(19) United States
(12) Patent Application Publication
(10) Pub. No.: US 2025/0267543 A1
(43) Pub. Date: Aug. 21, 2025

(54) COMMUNICATION CONTROL METHOD

(71) Applicant: KYOCERA Corporation, Kyoto (JP)

(72) Inventor: Masato FUJISHIRO, Yokohama-shi (JP)

(73) Assignee: KYOCERA Corporation, Kyoto (JP)

(21) Appl. No.: 19/092,521

(22) Filed: Mar. 27, 2025

Related U.S. Application Data
(63) Continuation of application No. PCT/JP2023/034428, filed on Sep. 22, 2023.

(30) Foreign Application Priority Data
Sep. 28, 2022 (JP) 2022-155349

(51) Int. Cl. H04W 36/08; H04W 88/04

(52) U.S. Cl. CPC H04W 36/08; H04W 88/04

(57) ABSTRACT

In an aspect, a communication control method is used in a cellular communication system. The communication control method includes transmitting, by a mobile relay node to a target donor node, an F1 setup request message including a first physical cell ID used in the mobile relay node. In addition, the communication control method includes, in response to reception of the F1 setup request message, transmitting, by the target donor node to a neighbor donor node adjacent to the target donor node and other than a source donor node, a PCI request message including the first physical cell ID in order to perform an inquiry as to whether the first physical cell ID is usable.

### RELATED APPLICATIONS

The present application is a continuation based on PCT Application No. PCT/JP2023/034428, filed on Sep. 22, 2023, which claims the benefit of Japanese Patent Application No. 2022-155349 filed on Sep. 28, 2022. The content of which is incorporated by reference herein in their entirety.

### TECHNICAL FIELD

The present disclosure relates to a communication control method used in a cellular communication system.

### BACKGROUND

In the third generation partnership project (3GPP) (registered trademark; the same applies below) which is a standardization project for cellular communication systems, the introduction of a new relay node referred to as an integrated access and backhaul (IAB) node is being considered (see, for example, Non-Patent Document 1). One or more relay nodes are involved in communication between a base station and a user equipment and perform relay for the communication.

### CITATION LIST

### Non-Patent Literature

Non-Patent Document 1: 3GPP TS 38.300 V17.1.0 (June 2022)

### SUMMARY

In a first aspect, a communication control method is used in a cellular communication system. The communication control method includes transmitting, by a mobile relay node to a target donor node, an F1 setup request message including a first physical cell ID used in the mobile relay node. In addition, the communication control method includes, in response to reception of the F1 setup request message, transmitting, by the target donor node to a neighbor donor node adjacent to the target donor node and other than a source donor node, a PCI request message including the first physical cell ID in order to perform an inquiry as to whether the first physical cell ID is usable.

In a second aspect, a communication control method is used in a cellular communication system. The communication control method includes transmitting, by a mobile relay node to a target donor node, an F1 setup request message including a first physical cell ID used in the mobile relay node. In addition, the communication control method includes, in response to reception of the F1 setup request message, transmitting, by the target donor node to a neighbor donor node adjacent to the target donor node and other than a source donor node, a serving cell information request message for requesting provision of a physical cell ID to be used in the neighbor donor node.

In a third aspect, a communication control method is used in a cellular communication system. The communication control method includes transmitting, by a mobile relay node to a target donor node, an F1 setup request message including a first physical random access channel (PRACH) resource used in the mobile relay node. In addition, the communication control method includes, in response to reception of the F1 setup request message, transmitting, by the target donor node to a neighbor donor node adjacent to the target donor node and other than a source donor node, a PRACH request message including the first PRACH resource in order to perform an inquiry as to whether the first PRACH resource is usable.

In a fourth aspect, a communication control method is used in a cellular communication system. The communication control method includes transmitting, by a mobile relay node to a target donor node, an F1 setup request message including a first PRACH resource used in the mobile relay node. In addition, the communication control method includes, in response to reception of the F1 setup request message, transmitting, by the target donor node to a neighbor donor node adjacent to the target donor node and other than a source donor node, a serving cell information request message for requesting provision of a PRACH resource to be used in the neighbor donor node.

### BRIEF DESCRIPTION OF THE DRAWINGS

FIG. 1 is a diagram illustrating a configuration example of a cellular communication system according to an embodiment.

FIG. 2 is a diagram illustrating a relationship between an IAB node, parent nodes, and child nodes.

FIG. 3 is a diagram illustrating a configuration example of a gNB (base station) according to the embodiment.

FIG. 4 is a diagram illustrating a configuration example of an IAB node (relay node) according to the embodiment.

FIG. 5 is a diagram illustrating a configuration example of a UE (user equipment) according to the embodiment.

FIG. 6 is a diagram illustrating an example of a protocol stack related to an RRC connection and a NAS connection of an IAB-MT.

FIG. 7 is a diagram illustrating an example of a protocol stack related to an F1-U protocol.

FIG. 8 is a diagram illustrating an example of a protocol stack related to an F1-C protocol.

FIGS. 9A and 9B are diagrams illustrating an example of full migration according to a first embodiment.

FIGS. 10A and 10B are diagrams illustrating an example of full migration according to the first embodiment.

FIG. 11 is a diagram illustrating an operation example according to the first embodiment.

FIG. 12 is a diagram illustrating another operation example according to the first embodiment.

### DESCRIPTION OF EMBODIMENTS

The present disclosure provides a communication control method that enables a mobile relay node to appropriately communicate with a user equipment under the control of the mobile relay node.

A cellular communication system according to an embodiment will be described with reference to the drawings. In the description of the drawings, the same or similar parts are denoted by the same or similar reference signs.

### First Embodiment

### Configuration of Cellular Communication System

A configuration example of the cellular communication system according to an embodiment is described. A cellular communication system 1 according to an embodiment is a 3GPP 5G system. Specifically, a radio access scheme in the cellular communication system 1 is a new radio (NR) being a 5G radio access scheme. Note that long term evolution (LTE) may be at least partially applied to the cellular communication system 1. A future cellular communication system such as 6G may be applied to the cellular communication system 1.

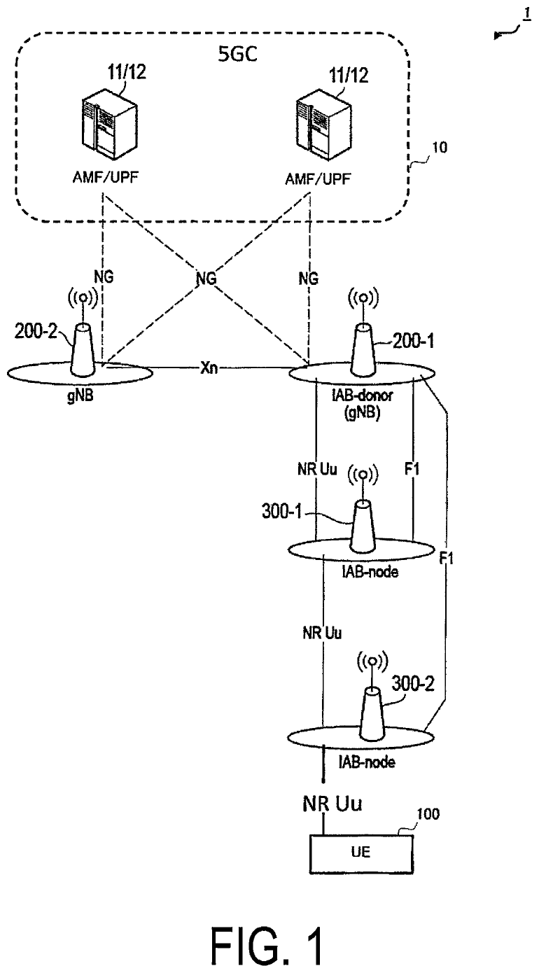

FIG. 1 is a diagram illustrating a configuration example of the cellular communication system 1 according to the embodiment.

As shown in FIG. 1, the cellular communication system 1 includes a 5G core network (5GC) 10, a user equipment (UE) 100, base station devices (hereinafter may be referred to as “base stations”) 200-1 and 200-2, and IAB nodes 300-1 and 300-2. The base station 200 may be referred to as a gNB.

In the following, an example in which the base station 200 is an NR base station will be mainly described, but the base station 200 may also be an LTE base station (that is, an eNB).

In the following, the base stations 200-1 and 200-2 may be referred to as gNBs 200 (or base station 200), and the IAB nodes 300-1 and 300-2 may be referred to as IAB nodes 300.

The 5GC 10 includes an access and mobility management function (AMF) 11 and a user plane function (UPF) 12. The AMF 11 is a device that performs various mobility controls for the UE 100. The AMF 11 communicates with the UE 100 using non-access stratum (NAS) signaling to manage information on an area in which the UE 100 exists. The UPF 12 is a device that performs transfer control of user data, and the like.

Each gNB 200 is a fixed radio communication node and manages one or more cells. The term “cell” is used to indicate a minimum unit of a radio communication area. The term “cell” may be used to indicate a function or resource for performing radio communication with the UE 100. One cell belongs to one carrier frequency. Hereinafter, a cell and a base station may be used without distinction.

Each gNB 200 is interconnected with the 5GC 10 via an interface referred to as an NG interface. FIG. 1 illustrates two gNBs, that is, a gNB 200-1 and a gNB 200-2, connected to the 5GC 10.

Each gNB 200 may be divided into a central unit (CU) and a distributed unit (DU). The CU and the DU are interconnected via an interface referred to as an F1 interface. An F1 protocol is a communication protocol between the CU and the DU, and includes an F1-C protocol, which is a control plane protocol, and an F1-U protocol, which is a user plane protocol.

The cellular communication system 1 supports IAB, which enables radio relay of NR access using an NR for backhaul. The donor gNB 200-1 (or donor node; hereinafter may be referred to as “donor node”) is a terminal node of the NR backhaul on the network side, and is a donor base station having additional functions for supporting IAB. The backhaul is capable of multi-hopping via a plurality of hops (that is, a plurality of IAB nodes 300).

FIG. 1 illustrates an example in which the IAB node 300-1 is wirelessly connected to the donor node 200-1, the IAB node 300-2 is wirelessly connected to the IAB node 300-1, and the F1 protocol is transmitted by two backhaul hops.

The UE 100 is a mobile radio communication device that performs radio communication with a cell. The UE 100 may be any device that performs radio communication with the gNB 200 or the IAB node 300. For example, the UE 100 is a mobile phone terminal and/or a tablet terminal, a laptop PC, a sensor, a device provided in a sensor, a vehicle, a device provided in a vehicle, an aircraft, or a device provided in an aircraft. The UE 100 is wirelessly connected to the IAB node 300 or the gNB 200 via an access link. FIG. 1 illustrates an example in which the UE 100 is wirelessly connected to the IAB node 300-2. The UE 100 indirectly communicates with the donor node 200-1 via the IAB node 300-2 and the IAB node 300-1.

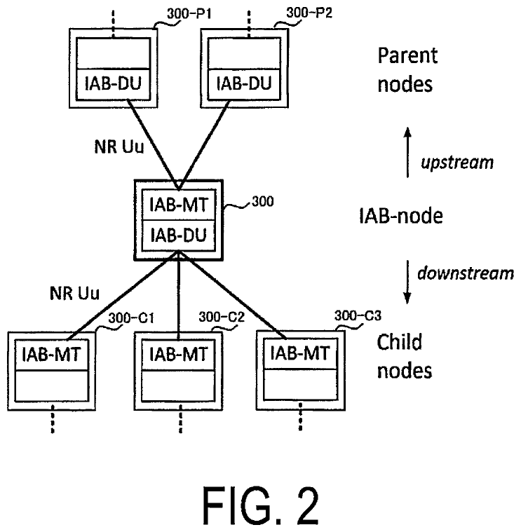

FIG. 2 is a diagram illustrating an example of a relationship between the IAB node 300, parent nodes, and child nodes.

As illustrated in FIG. 2, each IAB node 300 includes an IAB-DU equivalent to a base station function unit and an IAB-MT (Mobile Termination) equivalent to a user equipment function unit.

Adjacent nodes (that is, upper nodes) on an NR Uu radio interface of the IAB-MT are referred to as parent nodes. The parent node is a DU of a parent IAB node or the donor node 200. A radio link between the IAB-MT and the parent node is referred to as a backhaul link (BH link). FIG. 2 illustrates an example in which the parent nodes of the IAB node 300 are IAB nodes 300-P1 and 300-P2. A direction toward the parent nodes is referred to as upstream. From the perspective of the UE 100, the upper node of the UE 100 may correspond to a parent node.

Adjacent nodes (that is, lower nodes) on the NR access interface of the IAB-DU are referred to as child nodes. The IAB-DU manages the cell, similar to the gNB 200. The IAB-DU terminates the NR Uu radio interface to the UE 100 and the lower IAB nodes. The IAB-DU supports the F1 protocol to the CU of the donor node 200-1. FIG. 2 illustrates an example in which the child nodes of the IAB node 300 are IAB nodes 300-C1 to 300-C3, but the child node of the IAB node 300 may also include the UE 100. A direction toward the child nodes is referred to as downstream.

All of the IAB nodes 300 connected to the donor node 200 via one or more hops form a directed acyclic graph (DAG) topology (hereinafter may be referred to as “topology”) with the donor node 200 as the root. In this topology, as illustrated in FIG. 2, adjacent nodes on the IAB-DU interface are child nodes, and adjacent nodes on the IAB-MT interface are parent nodes. The donor node 200 performs central management including resource, topology, and route management of the IAB topology. The donor node 200 is a gNB that provides network access to the UE 100 via a network of backhaul links and access links.

### Configuration of Base Station

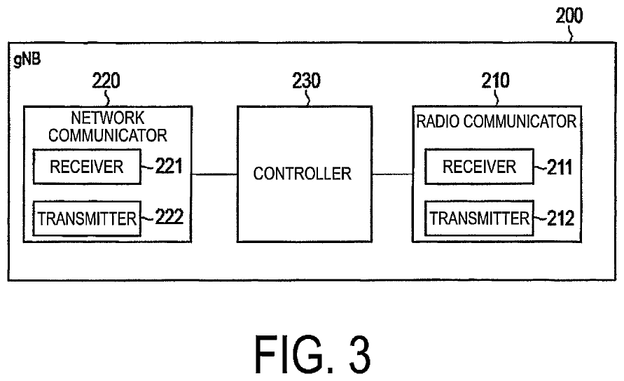

The configuration of the gNB 200, which is a base station according to the embodiment, will be described. FIG. 3 is a diagram illustrating a configuration example of the gNB 200. As illustrated in FIG. 3, the gNB 200 includes a radio communicator 210, a network communicator 220, and a controller 230.

The radio communicator 210 performs radio communication with the UE 100 and the IAB node 300. The radio communicator 210 includes a receiver 211 and a transmitter 212. The receiver 211 performs various types of reception under the control of the controller 230. The receiver 211 includes an antenna, and converts (down-converts) a radio signal received by the antenna into a baseband signal (reception signal) and outputs the signal to the controller 230. The transmitter 212 performs various types of transmission under the control of the controller 230. The transmitter 212 includes an antenna, and converts (up-converts) a baseband signal (transmission signal) output by the controller 230 into a radio signal and transmits the signal from the antenna.

The network communicator 220 performs wired communication (or radio communication) with the 5GC 10 and wired communication (or radio communication) with other adjacent gNBs 200. The network communicator 220 includes a receiver 221 and a transmitter 222. The receiver 221 performs various types of reception under the control of the controller 230. The receiver 221 receives a signal from the outside and outputs the reception signal to the controller 230. The transmitter 222 performs various types of transmission under the control of the controller 230. The transmitter 222 transmits a transmission signal output by the controller 230 to the outside.

The controller 230 performs various types of control for the gNB 200. The controller 230 includes at least one memory and at least one processor electrically connected to the memory. The memory stores a program to be executed by the processor and information to be used for processing performed by the processor. The processor may include a baseband processor and a CPU. The baseband processor performs modulation, demodulation, coding, decoding, and the like of a baseband signal. The CPU executes the program stored in the memory to thereby perform various types of processing. The processor performs processing of layers to be described below. The controller 230 may perform all of the processing and operations in the gNB 200 in each embodiment to be described below.

### Configuration of Relay Node

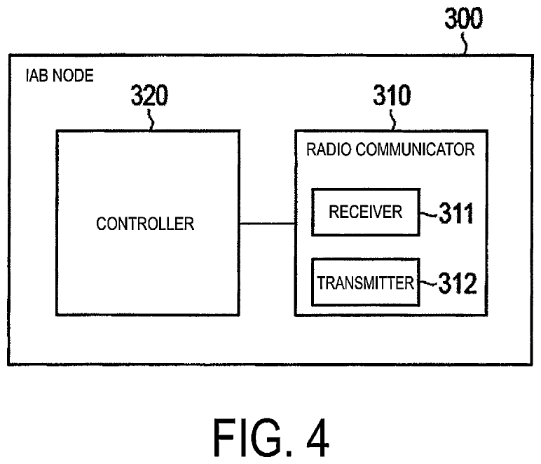

A configuration of the IAB node 300 that is a relay node (or a relay node apparatus, which may hereinafter be referred to as a “relay node”) according to the embodiment will be described. FIG. 4 is a diagram illustrating a configuration example of the IAB node 300. As illustrated in FIG. 4, the IAB node 300 includes a radio communicator 310 and a controller 320. The IAB node 300 may include a plurality of radio communicators 310.

The radio communicator 310 performs radio communication (BH link) with the gNB 200 and radio communication (access link) with the UE 100. The radio communicator 310 for BH link communication and the radio communicator 310 for access link communication may be provided separately.

The radio communicator 310 includes a receiver 311 and a transmitter 312. The receiver 311 performs various types of reception under the control of the controller 320. The receiver 311 includes an antenna, and converts (down-converts) a radio signal received by the antenna into a baseband signal (reception signal) and outputs the converted signal to the controller 320. The transmitter 312 performs various types of transmission under the control of the controller 320. The transmitter 312 includes an antenna, and converts (up-converts) a baseband signal (transmission signal) output by the controller 320 into a radio signal and transmits the converted signal from the antenna.

The controller 320 performs various types of control in the IAB node 300. The controller 320 includes at least one memory and at least one processor electrically connected to the memory. The memory stores programs executed by the processor and information used in processing performed by the processor. The processor may include a baseband processor and a CPU. The baseband processor performs modulation, demodulation, coding, decoding, and the like of a baseband signal. The CPU executes the program stored in the memory to thereby perform various types of processing. The processor performs processing of layers to be described below. The controller 320 may perform each process or each operation in the IAB node 300 in each embodiment to be described below.

### Configuration of User Equipment

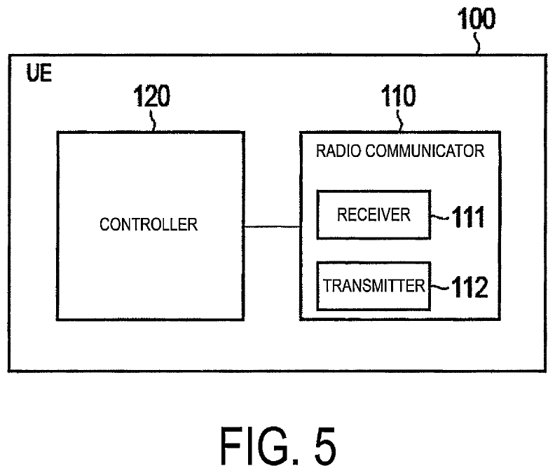

The configuration of the UE 100, which is a user equipment according to the embodiment, will be described. FIG. 5 is a diagram illustrating a configuration example of the UE 100. As illustrated in FIG. 5, the UE 100 includes a radio communicator 110 and a controller 120.

The radio communicator 110 performs radio communication in an access link, that is, radio communication with the gNB 200 and radio communication with the IAB node 300. The radio communicator 110 may also perform radio communication in a side link, that is, radio communication with other UEs 100. The radio communicator 110 includes a receiver 111 and a transmitter 112. The receiver 111 performs various types of reception under the control of the controller 120. The receiver 111 includes an antenna, and converts (down-converts) a radio signal received by the antenna into a baseband signal (reception signal) and outputs the converted signal to the controller 120. The transmitter 112 performs various types of transmission under the control of the controller 120. The transmitter 112 includes an antenna, and converts (up-converts) a baseband signal (transmission signal) output by the controller 120 into a radio signal and transmits the converted signal from the antenna.

The controller 120 performs various types of control in the UE 100. The controller 120 includes at least one memory and at least one processor electrically connected to the memory. The memory stores a program to be executed by the processor and information to be used for processing performed by the processor. The processor may include a baseband processor and a CPU. The baseband processor performs modulation, demodulation, coding, decoding, and the like of a baseband signal. The CPU executes the program stored in the memory to thereby perform various types of processing. The processor performs processing of layers to be described below. The controller 120 may perform each process in the UE 100 in each embodiment to be described below.

### Configuration of Protocol Stack

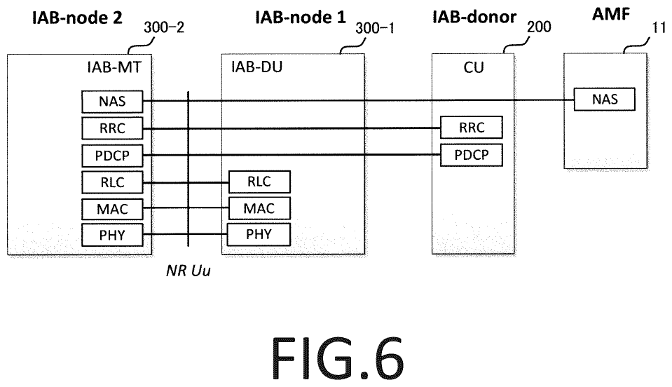

A configuration of a protocol stack according to the embodiment will be described. FIG. 6 is a diagram illustrating an example of a protocol stack related to RRC connection and NAS connection of the IAB-MT.

As illustrated in FIG. 6, the IAB-MT of the IAB node 300-2 includes a physical (PHY) layer, a medium access control (MAC) layer, a radio link control (RLC) layer, a packet data convergence protocol (PDCP) layer, a radio resource control (RRC) layer, and a non-access stratum (NAS) layer.

The PHY layer performs coding, decoding, modulation, demodulation, antenna mapping and demapping, and resource mapping and demapping. Data and control information are transmitted between the PHY layer of the IAB-MT of the IAB node 300-2 and the PHY layer of the IAB-DU of the IAB node 300-1 via a physical channel.

The MAC layer performs priority control of data, retransmission processing through hybrid ARQ (HARQ: Hybrid Automatic Repeat reQuest), a random access procedure, and the like. Data and control information are transmitted between the MAC layer of the IAB-MT of the IAB node 300-2 and the MAC layer of the IAB-DU of the IAB node 300-1 via a transport channel. The MAC layer of the IAB-DU includes a scheduler. The scheduler determines a transport format (transport block size, modulation and coding scheme (MCS)) and assigned resource blocks for an uplink and a downlink.

The RLC layer transmits data to the RLC layer on the reception side by using functions of the MAC layer and the PHY layer. Data and control information are transmitted between the RLC layer of the IAB-MT of the IAB node 300-2 and the RLC layer of the IAB-DU of the IAB node 300-1 via a logical channel.

The PDCP layer performs header compression/decompression and encryption/decryption. Data and control information are transmitted between the PDCP layer of the IAB-MT of the IAB node 300-2 and the PDCP layer of the donor node 200 via a radio bearer.

The RRC layer controls the logical channel, the transport channel, and the physical channel in accordance with establishment, re-establishment, and release of the radio bearer. RRC signaling for various settings is transmitted between the RRC layer of the IAB-MT of the IAB node 300-2 and the RRC layer of the donor node 200. When an RRC connection with the donor node 200 is present, the IAB-MT is in an RRC connected state. When no RRC connection with the donor node 200 is present, the IAB-MT is in an RRC idle state.

The NAS layer positioned at an upper layer of the RRC layer performs session management, mobility management, and the like. NAS signaling is transmitted between the NAS layer of the IAB-MT of the IAB node 300-2 and the AMF 11.

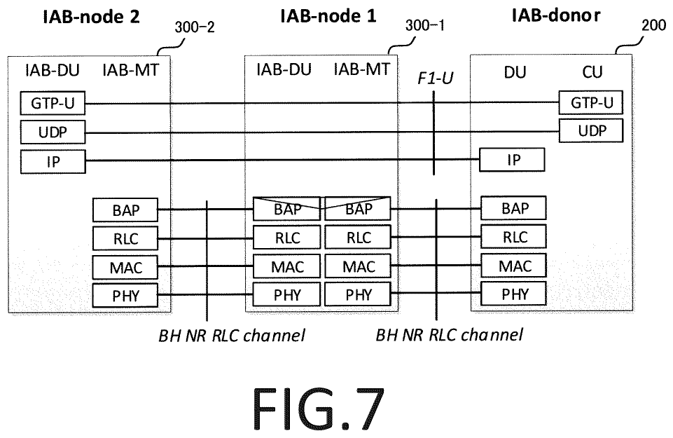

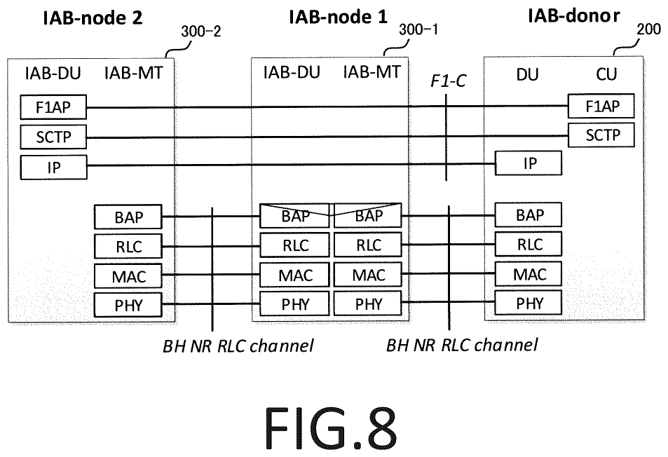

FIG. 7 is a diagram illustrating a protocol stack related to the F1-U protocol. FIG. 8 is a diagram illustrating a protocol stack related to the F1-C protocol. Here, an example in which the donor node 200 is divided into a CU and a DU is shown.

As illustrated in FIG. 7, the IAB-MT of the IAB node 300-2, the IAB-DU of the IAB node 300-1, the IAB-MT of the IAB node 300-1, and the DU of the donor node 200 each includes a backhaul adaptation protocol (BAP) layer as an upper layer of the RLC layer. The BAP layer is a layer for performing a routing process and a bearer mapping/demapping process. In the backhaul, the IP layer is transmitted via the BAP layer, which allows routing by a plurality of hops.

In each backhaul link, a protocol data unit (PDU) of the BAP layer is transmitted by a backhaul RLC channel (BH NR RLC channel). A plurality of backhaul RLC channels are configured in each BH link, thus enabling traffic prioritization and quality of service (QoS) control. The PDU of the BAP is associated with the backhaul RLC channel by the BAP layer of each IAB node 300 and the BAP layer of the donor node 200.

As illustrated in FIG. 8, the protocol stack of the F1-C protocol includes an F1AP layer and an SCTP layer instead of a GTP-U layer and an UDP layer illustrated in FIG. 7.

In the following, processes or operations performed in the IAB-DU and IAB-MT of the IAB may be simply described as processes or operations of the “IAB”. For example, the transmission of a message of the BAP layer to the IAB-MT of the IAB node 300-2 by the IAB-DU of the IAB node 300-1 will be described as the transmission of the message to the IAB node 300-2 by the IAB node 300-1. Processes or operations of the DU or CU of the donor node 200 may also be described simply as processes or operations of the “donor node.”

An upstream direction and an uplink (UL) direction may be used without distinction. A downstream direction and a downlink (DL) direction may be used without distinction.

### Mobile IAB Node

At present, 3GPP has started to study the introduction of a mobile IAB node. The mobile IAB node is, for example, a mobile IAB node. The mobile IAB node may be a movable IAB node. The mobile IAB node may be an IAB node that is capable of moving. The mobile IAB node may be an IAB node that is currently stationary but is certain to move in the future (or is expected to move in the future).

The mobile IAB node allows, for example, the UE 100 under the control of the mobile IAB node to receive services from the mobile IAB node while moving in accordance with the movement of the mobile IAB node. For example, a case is assumed in which a user (or UE 100) who is getting on a vehicle receives services via a mobile IAB node installed in the vehicle.

On the other hand, in contrast to the mobile IAB node, an IAB node that does not move also exists. Such an IAB node may be referred to as an intermediate IAB node. The intermediate IAB node is, for example, an IAB node that does not move. The intermediate IAB node may be a stationary IAB node. The intermediate IAB node may be a stationary IAB node. The intermediate IAB node may be an IAB node that is stationary (or does not move) in a state of being installed at its installation location. The intermediate IAB node may be a stationary IAB node that does not move. The intermediate IAB node may be a fixed IAB node.

The mobile IAB node can also be connected to the intermediate IAB node. The mobile IAB node can also be connected to the donor node 200. The mobile IAB node can also change its connection destination due to its movement (migration or handover). A connection source may be the intermediate IAB node. The connection source may be the donor node 200. The connection destination may be the intermediate IAB node. The connection destination may be the donor node 200.

In the following, the migration of the mobile IAB node and the handover of the mobile IAB node may be used without distinction.

In the following, the mobile IAB node may be a “mobile IAB node”, or may be “migrating IAB node”. In either case, the node may be referred to as a mobile IAB node.

### Full Migration of Mobile IAB Node

The mobile IAB node may move between the donor nodes (IAB-donors) 200.

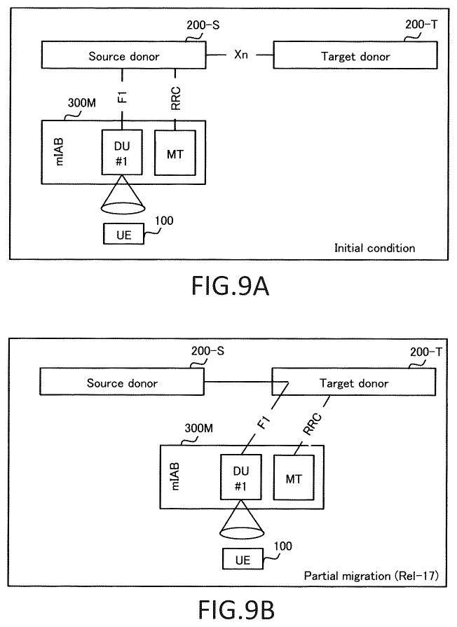

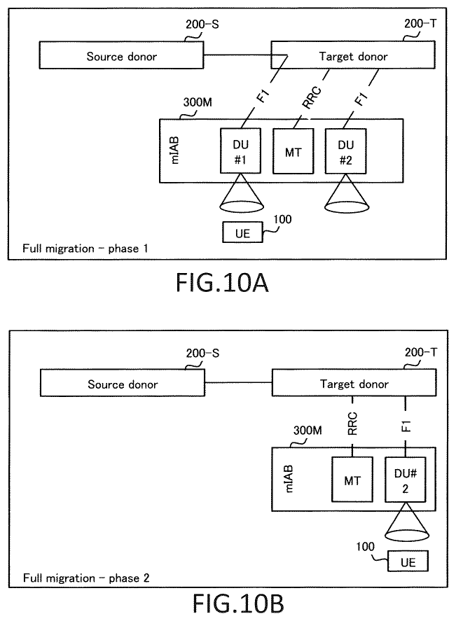

FIGS. 9A to 10B are diagrams illustrating an example of a procedure when a mobile IAB node 300M moves from a source donor node 200-S to a target donor node 200-T. The mobile IAB node 300M accommodates the UE 100 under its control. FIG. 9A illustrates an example in which the UE 100 exists in a cell range formed by an IAB-DU #1 of the mobile IAB node 300M. The UE 100 can move together with the mobile IAB node 300M.

FIG. 9A illustrates an example of an initial condition. The IAB-DU #1 of the mobile IAB node 300M has established an F1 connection with the CU of the source donor node 200-S. The IAB-MT of the mobile IAB node 300M has also established an RRC connection with the CU of the source donor node 200-S.

FIG. 9B illustrates an example of a case where the mobile IAB node 300M has moved to the target donor node 200-T, resulting in a state of partial migration with respect to the target donor node 200-T. As illustrated in FIG. 9B, in the partial migration, the IAB-DU #1 (and UE 100) of the mobile IAB node 300M is terminated in the CU of the source donor node 200-S, while the IAB-MT of the mobile IAB node 300M has moved to the CU of the target donor node 200-T. The IAB-MT of the mobile IAB node 300M has established an RRC connection with the CU of the target donor node 200-T. The IAB-DU of the mobile IAB node 300M has established an F1 connection with the source donor node 200-S. The partial migration refers to, for example, a state in which the connection of the UE 100 under the control of the mobile IAB node 300M remains in the source donor node 200-S via the IAB-DU #1 of the mobile IAB node 300M.

FIG. 10A illustrates an example of a case where the mobile IAB node 300M subsequently enters a state of a phase 1 of full migration with respect to the target donor node 200-T. In the phase 1 of the full migration, the UE 100 remains connected to the source donor node 200-S via the IAB-DU #1, but a new IAB-DU #2 has established an F1 connection with the CU of the target donor node 200-T. Here, the IAB-DU #1 and the IAB-DU #2 may be logical IAB-DUs. One physical IAB-DU may include two logical IAB-DUs (IAB-DU #1 and IAB-DU #2).

FIG. 10B illustrates an example of a case where the mobile IAB node 300M subsequently enters a state of a phase 2 of full migration with respect to the target donor node 200-T. In the phase 2 of the full migration, the connection of the mobile IAB node 300M (and UE 100) has moved from the CU of the source donor node 200-S to the CU of the target donor node 200-T. The full migration refers to, for example, a state in which the connection of the UE 100 has moved to the target donor node 200-T via the IAB-DU #2 of the mobile IAB node 300M.

In addition, movement between CUs using two DUs (IAB-DU #1 and IAB-DU #2) by the mobile IAB node 300M may be referred to as “dual DU approach.” For example, the dual DU approach is performed when the UE 100 moves from one CU and DU to the other CU and DU.

### Communication Control Method According to First Embodiment

A physical cell ID (PCI) is an identifier used to identify a cell. With regard to a PCI, a problem of a PCI collision may occur.

For example, a case where the same PCI is used between adjacent cells when a UE located between the adjacent cells measures a radio wave strength for one cell is assumed. In such a case, the UE 100 is expected to measure a radio wave intensity for a radio signal from one cell, but may measure a radio wave strength by combining two radio signals with a radio signal from the other cell as the radio signal from the same cell. For this reason, the UE may select an inappropriate cell at the time of cell search to start synchronization with the cell or transmit an inappropriate measurement report to perform a handover to another cell which is not a correct target cell.

In this manner, a problem caused by using the same PCI between different cells may be referred to as a “PCI collision”. In general, a PCI collision can be avoided by performing cell setting so that the same PCI is not used for an adjacent cell adjacent to a certain cell.

On the other hand, the mobile IAB node 300M may move between the donor nodes 200 as described above. Due to the movement (for example, full migration) of the mobile IAB node 300M, a PCI used in the cell under the control of the mobile IAB node 300M and a PCI used in the cell under the control of the donor node 200, which is a movement destination, may be the same or may overlap each other. In this case, the UE 100 under the control of the mobile IAB node 300M may be unable to identify the IAB-DU of the mobile IAB node 300M and the DU of the donor node 200, and a PCI collision may occur.

On the other hand, it is also conceivable that, for example, “1024” PCIs used in an NR are divided into PCIs dedicated to mobile IAB nodes and the other PCIs (for example, fixed cells or macro cells) and used. However, for example, even when “512” PCIs are assigned to PCIs dedicated to mobile IAB nodes, only “512” PCIs physically exist. For this reason, when a unique (global) PCI is assigned to each mobile IAB node 300M, only “512” cells can be accommodated as cells for the mobile IAB node. When a unique (global) PCI is not assigned to each mobile IAB node 300M (that is, when a PCI is repeatedly assigned), only “512” PCIs exist, and thus a PCI collision may occur when the mobile IAB nodes 300M approach each other.

An object of the first embodiment is to enable the mobile IAB node 300M to appropriately communicate with the UE 100 under the control of the mobile IAB node 300M, by avoiding a PCI collision in the mobile IAB node 300M.

For this reason, in the first embodiment, first, a mobile relay node (for example, the mobile IAB node 300M) transmits an F1 setup request message including a first physical cell ID to be used in the mobile relay node to a target donor node (for example, the target donor node 200-T). Second, in response to the reception of the F1 setup request message, the target donor node transmits a request message including the first physical cell ID to a neighbor donor node which is adjacent to the target donor node and other than the source donor node, to perform an inquiry as to whether the first physical cell ID can be used.

This allows, for example, the neighbor donor node to recognize PCIs to be used by the mobile IAB node 300M. For this reason, the neighbor donor node can cause a PCI matching the PCI being used by the neighbor donor node itself, among the PCIs, not to be used, and can cause a PCI that is not used by the neighbor donor node itself to be used. This allows the mobile IAB node 300M to avoid a PCI collision with neighbor donor nodes. Thus, even when the mobile IAB node 300M moves to the target donor node 200-T, the mobile IAB node 300M can appropriately communicate with the UE 100 under the control of the mobile IAB node 300M.

### Operation Example According to First Embodiment

An operation example according to the first embodiment will be described.

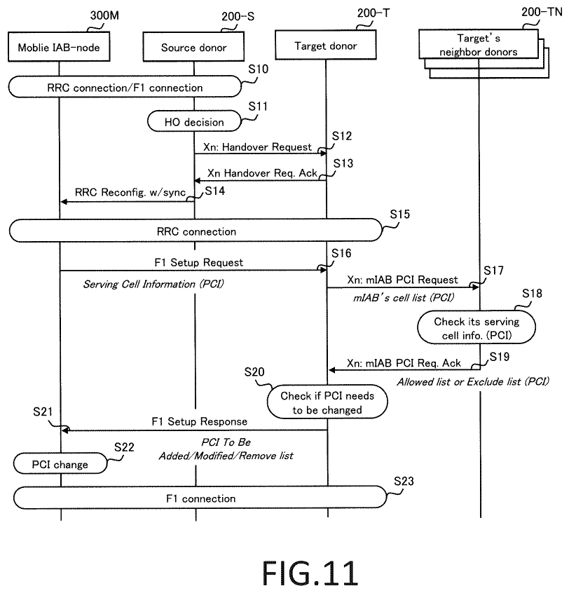

FIG. 11 is a diagram illustrating an operation example according to the first embodiment. FIG. 11 illustrates an example in which the mobile IAB node 300M performs a handover from the source donor node 200-S to the target donor node 200-T. The neighbor donor node 200-TN is a donor node 200 that is adjacent to the target donor node 200-T and refers to a donor node 200 other than the source donor node 200-S.

As illustrated in FIG. 11, in step S10, the mobile IAB node 300M has established an RRC connection with the source donor node, and has also established an F1 connection. For example, as in FIG. 9A, the IAB-DU of the mobile IAB node 300M establishes an RRC connection with the CU of the source donor node 200-S, and the IAB-MT of the mobile IAB node 300M establishes an F1 connection with the CU of the source donor node 200-S.

In step S11, the source donor node 200-S determines to handover the mobile IAB node 300M to the target donor node 200-T.

In step S12, the source donor node 200-S transmits a handover request message to the target donor node 200-T. For example, the CU of the source donor node 200-S transmits a handover request (HANDOVER REQUEST) message, which is an XNaP message, to the CU of target donor node 200-T.

In step S13, in response to the reception of the handover request message, the target donor node 200-T transmits a handover request acknowledge message accepting the handover request to the source donor node 200-S. For example, in response to the reception of the handover request (HANDOVER REQUEST) message, the CU of the target donor node 200-T transmits a handover request acknowledge (HANDOVER REQUEST ACKNOWLEDGEMENT) message to the CU of the source donor node 200-S.

In step S14, the source donor node 200-S transmits an RRC message (RRC Reconfiguration (RRCReconfiguration) message) to the mobile IAB node 300M in response to the reception of the handover request acknowledge message. The RRC message includes information (ReconfigurationwithSync) for the mobile IAB node 300M to establish an RRC connection with the target donor node 200-T. For example, the CU of the source donor node 200-S transmits the RRC message to the IAB-MT of the mobile IAB node 300M.

In step S15, the mobile IAB node 300M establishes an RRC connection with the target donor node 200-T. For example, the IAB-MT of the mobile IAB node 300M establishes an RRC connection with the CU of the target donor node 200-T (for example, FIG. 9B).

In step S16, the mobile IAB node 300M transmits an F1 setup request (F1 SETUP REQUEST) message to establish an F1 connection with the target donor node 200-T. At this time, the mobile IAB node 300M transmits an F1 setup request message including a PCI (for example, a first physical cell ID) used (or to be used) in its own IAB-DU. The PCI may be in a list format. For example, the IAB-DU of the mobile IAB node 300M includes the PCI in serving cell information (Served Cell Information) included in the F1 setup request message and transmits it to the CU of the target donor node 200-T.

In step S17, in response to the reception of the F1 setup request message, the target donor node 200-T transmits a PCI request (mIAB PCI Request) message including the PCI to be used in the mobile IAB node 300M to the neighbor donor node 200-TN. The PCI request message may be a message for requesting that the PCI used in the mobile IAB node 300M is also used in the neighbor donor node 200-TN. The PCI request message may be a message for performing an inquiry as to whether the PCI used in the mobile IAB node 300M can be used in the neighbor donor node 200-TN. The target donor node 200-T extracts the PCI to be used in the mobile IAB node 300M from the F1 setup request message (step S16) and transmits a PCI request message including the PCI to the neighbor donor node 200-TN. For example, the CU of the target donor node 200-T transmits a PCI request message as an Xn message to the CU of the neighbor donor node 200-TN. When a plurality of neighbor donor nodes 200-TN are present, the CU of the target donor node 200-T transmits a PCI request message to the CU of each neighbor donor node 200-TN. The PCIs included in the PCI request message may be in a list format.

In step S18, in response to the reception of the PCI request message, the neighbor donor node 200-TN determines a PCI that can be used in the mobile IAB node 300M. For example, usable PCIs are determined as follows.

That is, the neighbor donor node 200-TN compares or checks the PCI included in the PCI request message (for example, the PCI used in the cell under the control of the mobile IAB node 300M) and the PCI being used by the neighbor donor node 200-TN itself (for example, the PCI used in the cell under the control of the neighbor donor node 200-TN or the cell under the control of the IAB node 300 which is under the control of the neighbor donor node 200-TN). Then, the neighbor donor node 200-TN determines a PCI that can be used in the mobile IAB node 300M depending on whether the PCI included in the PCI request message matches the PCI being used by the neighbor donor node 200-TN itself. When the two PCIs match each other, the neighbor donor node 200-TN determines that the PCI used in the mobile IAB node 300M cannot be used. This is because the PCI used by the mobile IAB node 300M is also used in the neighbor donor node 200-TN and a PCI collision occurs. On the other hand, when the two PCIs do not match each other, the neighbor donor node 200-TN determines that the PCI used in the mobile IAB node 300M can be used. This is because the PCI used by the mobile IAB node 300M is not used in the neighbor donor node 200-TN and a PCI collision does not occur. When the PCI is in a list format, PCI is compared one by one. Such processing may be performed in the CU of the neighbor donor node 200-TN.

In step S19, the neighbor donor node 200-TN transmits a PCI request acknowledge (mIAB PCI Request Acknowledge) message, which is a response message to the PCI request message (step S17), to the target donor node 200-T. The PCI request acknowledge message is a response message to the PCI request message (step S17). The PCI request acknowledge message includes the determination result in step S18.

First, the PCI request acknowledge message may include an allowed PCI list (AllowedPCI list). The allowed PCI list represents, for example, a list of PCIs (for example, second physical cell IDs) that can be used for the neighbor donor node 200-TN by the mobile IAB node 300M.

Second, an excluded PCI list (Exclude PCI list) may be included in the PCI request acknowledge message. The Exclude PCI list represents, for example, a list of unusable PCIs (for example, third physical cell IDs) that cannot be used for the neighbor donor node 200-TN by the mobile IAB node 300M.

Third, the PCI request acknowledge message may include information indicating that all of the PCIs included in the PCI request message are approved. The information may indicate that all of the PCIs used in the mobile IAB node 300M may be used for the neighbor donor node 200-TN.

Fourth, the PCI request acknowledge message may include information indicating that all of the PCIs included in the PCI request message are disapproved. The information may indicate that all of the PCIs used in the mobile IAB node 300M cannot be used for the neighbor donor node 200-TN.

For example, the CU of the neighbor donor node 200-TN transmits a PCI request message as an Xn message to the CU of the target donor node 200-T.

In step S20, in response to the reception of the PCI request acknowledge message, the target donor node 200-T confirms whether it is necessary to modify the PCI (for example, the first physical cell ID) used in the mobile IAB node 300M.

First, the target donor node 200-T confirms whether it is necessary to modify the PCI used in the mobile IAB node 300M in accordance with the information (Allowed PCI list or Exclude PCI list) included in the PCI request acknowledge message. For example, when the PCI request acknowledge message includes all information indicating approval, the target donor node 200-T confirms that the PCI does not need to be modified. For example, when the PCI request acknowledge message includes the Allowed PCI list, the target donor node 200-T confirms that the PCI used by the mobile IAB node 300M is modified to the PCI included in the list. Further, for example, when the PCI request acknowledge message includes the Exclude PCI list, the target donor node 200-T confirms that the PCI included in the list among the PCIs used by the mobile IAB node 300M is a PCI to be removed or confirms that the PCI is to be modified to a PCI other than the PCI included in the list. Further, for example, when the PCI request acknowledge message includes information indicating that all PCIs are disapproved, the target donor node 200-T confirms that all of the PCIs used by the mobile IAB node 300M are to be removed.

Second, the target donor node 200-T may confirm whether the PCI needs to be modified by comparing or checking the PCI and a PCI used in the cell under the control of the target donor node 200-T itself. For example, when the PCI request acknowledge message includes the Allowed PCI list, the target donor node 200-T may confirm whether the PCI included in the list is also being used by the target donor node 200-T itself, and when the PCI that is also being used by the target donor node 200-T itself is included, the target donor node 200-T may confirm that the PCI is to be removed. The target donor node 200-T may confirm that the PCI included in the Allowed PCI list need not be modified when the Allowed PCI list does not include any PCIs used by the target donor node 200-T itself.

The processing in step S20 may be performed in the CU of the target donor node 200-T.

In step S21, the target donor node 200-T transmits an F1 setup response (F1 SETUP RESPONSE) message to the mobile IAB node 300M. The F1 setup response message may include a PCI modified with respect to the PCI used by the mobile IAB node 300M, depending on a confirmation result (step S20) in the target donor node 200-T. Specifically, the F1 setup response message may include the following information.

First, the F1 setup response message may include a to-be-added-PCI list (PCI To Be Added List). The to-be-added-PCI list includes a list of PCIs that can be further used for the neighbor donor node 200-TN for the PCIs used by the mobile IAB node 300M (step S16 or step S17).

Second, the F1 setup response message may include a to-be-modified-PCI list (PCI To Be Modified List). For example, the to-be-modified-PCI list includes, among the PCIs used by the mobile IAB node 300M (step S16 or step S17), modified PCIs that can be used for the neighbor donor node 200-TN.

Third, a to-be-removed-PCI list (PCI To Be Remove List) may be included in the F1 setup response message. The to-be-removed-PCI list includes PCIs to be removed as PCIs which cannot be used for the neighbor donor node 200-TN among the PCIs (step S16 or step S17) used by the mobile IAB node 300M.

Fourth, the F1 setup response message may include association (or combination) information between the PCI used in the mobile IAB node 300M (for example, an old PCI) and the modified PCI (for example, a new PCI) confirmed by the target donor node 200-T.

The target donor node 200-T can transmit the F1 setup response message including the modified PCI to the mobile IAB node 300M by using the to-be-added-PCI list, the to-be-modified-PCI list, the to-be-removed-PCI list, or the like for the PCIs used by the mobile IAB node 300M.

For example, the CU of the target donor node 200-T transmits the F1 setup response message including the to-be-added-PCI list, the to-be-modified-PCI list, the to-be-removed-PCI list, or the like to the IAB-DU of the mobile IAB node 300M.

In step S22, the mobile IAB node 300M modifies the PCI in response to the reception of the F1 setup response message. For example, the IAB-DU of the mobile IAB node 300M modifies the PCI to be used by adding a PCI in accordance with the to-be-added-PCI list. For example, the IAB-DU of the mobile IAB node 300M modifies the PCI to be used in accordance with the to-be-modified-PCI list. Further, for example, the IAB-DU of the mobile IAB node 300M modifies the PCI to be used by removing the PCI included in the to-be-removed-PCI list from the PCIs to be used in accordance with the to-be-removed-PCI list.

In step S23, the mobile IAB node 300M establishes an F1 connection with the target donor node 200-T.

### Another Example of First Embodiment

Another example of the first embodiment will be described. In another example of the first embodiment, differences from the first embodiment will mainly be described.

Although an example in which the target donor node 200-T transmits the PCI to be used in the mobile IAB node 300M to the neighbor donor node 200-TN has been described in the first embodiment, the present disclosure is not limited thereto. For example, the target donor node 200-T may request the neighbor donor node 200-TN to provide the PCI being used in the neighbor donor node 200-TN. In this case, the target donor node 200-T determines whether the PCI used in the mobile IAB node 300M can be used in the neighbor donor node 200-TN.

Specifically, first, a mobile relay node (for example, the mobile IAB node 300M) transmits the F1 setup request message including the first physical cell ID to be used in the mobile relay node. Second, in response to the reception of the F1 setup request message, the target donor node transmits a serving cell information request message for requesting provision of a physical cell ID being used in a neighbor donor node to the neighbor donor node (for example, the neighbor donor node 200-TN) adjacent to the target donor node and other than the source donor node.

This allows the target donor node 200-T to transmit a PCI other than the PCI being used in the neighbor donor node 200-TN among the PCIs used in the mobile IAB node 300M to the mobile IAB node 300M as a PCI that can be used in the mobile IAB node 300M. Thus, in the cell under the control of the mobile IAB node 300M, a PCI collision with the neighbor donor node 200-TN can be avoided. Thus, the mobile IAB node 300M can appropriately communicate with the UE 100 under the control of the mobile IAB node 300M.

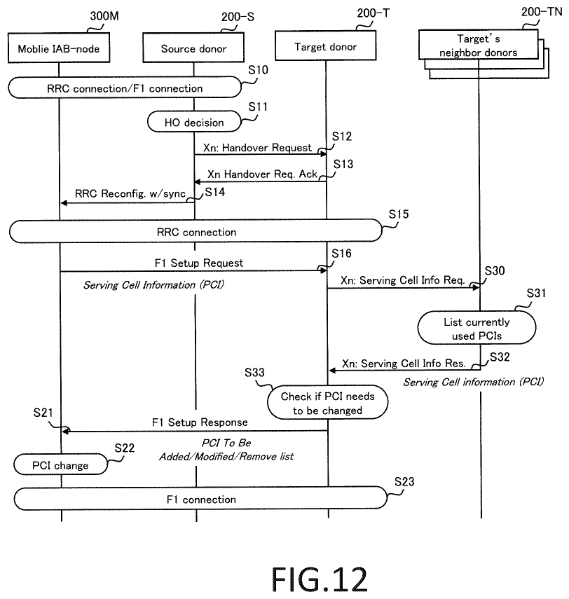

FIG. 12 is a flowchart showing an operation example of another example of the first embodiment. In FIG. 12, the same processes as those in the first embodiment are denoted by the same reference numerals.

In step S30, the target donor node 200-T transmits a serving cell information request (Serving Cell Information Request) message to the neighbor donor node 200-TN in response to the reception of the F1 setup request message (step S16). The serving cell information request message is a message for requesting provision of a PCI to be used in the neighbor donor node 200-TN. The serving cell information request message may be a message for requesting serving cell information being used in the neighbor donor node 200-TN. For example, the CU of the target donor node 200-T transmits the serving cell information request message as an Xn message to the CU of the neighbor donor node 200-TN.

In step S31, in response to the reception of the serving cell information request message, the neighbor donor node 200-TN lists up the PCIs being used in the neighbor donor node 200-TN.

In step S32, the neighbor donor node 200-TN transmits a serving cell information response message to the target donor node 200-T. The serving cell information response message is a response message to the serving cell information request message. The serving cell information response message includes a PCI (or a list of PCIs) to be used in the neighbor donor node 200-TN. The serving cell information response message may include an information element (Serving Cell Information) including serving cell information, and the information element may include the PCI. For example, the CU of the neighbor donor node 200-TN transmits the serving cell information response message as an Xn message to the CU of the target donor node 200-T.

In step S33, in response to the reception of the serving cell information response message, the target donor node 200-T confirms whether it is necessary to modify the PCI used in the mobile IAB node 300M. The confirmation itself may be the same as that in the first embodiment (step S18 or step S20). The target donor node 200-T may confirm usable PCIs by avoiding the PCI used in the neighbor donor node 200-TN for the PCIs used in the mobile IAB node 300M. As in the first embodiment, the target donor node 200-T may compare or check the PCI and a PCI (or PCI list) being used by the target donor node 200-T itself to confirm the PCI that can be used in the mobile IAB node 300M. Thereafter, as in the first embodiment, the target donor node 200-T transmits an F1 setup response message including a to-be-added-PCI list, a to-be-modified-PCI list, a to-be-removed-PCI list, or the like to the mobile IAB node 300M (step S21).

### Second Embodiment

A second embodiment will be described. In the second embodiment, differences from the first embodiment will mainly be described.

In the first embodiment, an embodiment for avoiding a PCI collision has been described, but the present disclosure is not limited thereto. For example, the present disclosure is also applicable to collision avoidance of a PRACH resource instead of the PCI collision.

The PRACH resource is, for example, a resource used by a UE 100 under the control of a mobile IAB node 300M to transmit a PRACH preamble signal that is first transmitted to the mobile IAB node 300M by the UE 100 when the UE 100 performs a random access procedure for the mobile IAB node 300M.

For example, when the mobile IAB node 300M moves between donor nodes 200, a PRACH resource being used in a cell under the control of the mobile IAB node 300M and a PRACH resource being used in a cell under the control of the donor node 200 may be the same resource. In this case, when a UE 100-1 under the control of the mobile IAB node 300M and a UE 100-2 under the control of the donor node 200 execute a random access procedure at the same time, the same PRACH resource is used and the two of the UE 100-1 and the UE 100-2 may fail in the random access procedure. Thus, the mobile IAB node 300M may be unable to appropriately communicate with the UE 100-1 under the control of the mobile IAB node 300M.

An object of the second embodiment is to enable the mobile IAB node 300M to avoid a collision of the PRACH resource and appropriately communication with the UE 100 under the control of the mobile IAB node 300M.

For this reason, in the second embodiment, first, a mobile relay node (for example, the mobile IAB node 300M) transmits an F1 setup request message including a first PRACH resource to be used in the mobile relay node to a target donor node (for example, a target donor node 200-T). Second, in response to the reception of the F1 setup request message, the target donor node transmits a PRACH request message including the first PRACH resource to a neighbor donor node (for example, a neighbor donor node 200-TN), which is adjacent to the target donor node and other than the source donor node, to perform an inquiry as to whether the first PRACH resource can be used.

This allows the neighbor donor node 200-TN to recognize the PRACH resource used by the mobile IAB node 300M. For this reason, the neighbor donor node 200-TN can cause resources matching the PRACH resource being used by the neighbor donor node 200-TN itself, among the PRACH resources, not to be used, and can cause resources not matching the PRACH resource used by the neighbor donor node 200-TN itself to be used. This allows the mobile IAB node 300M to avoid a collision of a PRACH resource between the UE 100-1 under the control of the mobile IAB node 300M and the UE 100-2 under the control of the neighbor donor node 200-TN and appropriately execute a random access procedure with each other. Thus, the mobile IAB node 300M can appropriately communicate with the UE 100-1 under the control of the mobile IAB node 300M.

The operation example according to the second embodiment can be implemented by replacing a PCI (or a PCI list) with an PRACH resource (or a PRACH resource list) in FIG. 11. For example, each step in FIG. 11 can be read as follows.

### Step S16

In step S16, the F1 setup request message includes a PRACH resource (for example, a first PRACH resource) to be used in the mobile IAB node 300M.

### Step S17

In step S17, instead of a PCI request message, a PRACH request (mIAB PRACH Request) message is transmitted from the target donor node 200-T to the neighbor donor node 200-TN. The PRACH request message may be a message for requesting that the PRACH resource used in the mobile IAB node 300M is also used in the neighbor donor node 200-TN. The PRACH request message may be a message for performing an inquiry as to whether the PRACH resource used in the mobile IAB node 300M can be used in the neighbor donor node 200-TN. The PRACH request message includes (a list of) PRACH resources to be used in the mobile IAB node 300M. The PRACH request message may also be an Xn message.

### Step S18

In step S18, the neighbor donor node 200-TN determines a PRACH resource that can be used in the mobile IAB node 300M. The neighbor donor node 200-TN may compare or check the PRACH resource included in the PRACH request message and the PRACH resource being used by the neighbor donor node 200-TN itself, and determine whether they match each other.

### Step S19

In step S19, the neighbor donor node 200-TN transmits a PRACH request acknowledge (mIAB PRACH Request Acknowledge) message, which is a response message to the PRACH request message, to the target donor node. The PRACH request acknowledge message includes a PRACH resource (for example, a second PRACH resources) that can be used in the mobile IAB node 300M. Specifically, the PRACH request acknowledge message may include an allowed PRACH list (Allowed PRACH list) representing a list of PRACH resources that can be used in the mobile IAB node 300M. The PRACH request acknowledge message may include an Exclude PRACH list representing a list of PRACH resources that cannot be used in the mobile IAB node 300M. The PRACH request acknowledge message may include information indicating that all of the PRACH resources included in the PRACH request message are approved. The PRACH request acknowledge message may include information indicating disapproval of all of the PRACH resources included in the PRACH request message (or information indicating that all of the PRACH resources cannot be used). The PRACH request acknowledge message may include association information between the PRACH resource to be used in the mobile IAB node 300M and the modified PRACH resource confirmed by the target donor node 200-T. The PRACH request acknowledge message may also be an Xn message.

### Step S20

In step S20, in response to the reception of the PRACH request acknowledge message, the target donor node 200-T confirms whether it is necessary to modify the PRACH resource to be used in the mobile IAB node 300M. The target donor node 200-T may perform the confirmation on the basis of information (such as the Allowed PRACH list or the Exclude PRACH list) included in the PRACH request acknowledge message. The target donor node 200-T may confirm whether it is necessary to modify the PRACH resource by comparing or checking the PRACH resource and a PRACH resource used in a cell under the control of the target donor node 200-T itself.

### Step S21

In step S21, the target donor node 200-T transmits an F1 setup response (F1 SETUP RESPONSE) message to the mobile IAB node 300M. The F1 setup response message may include a PRACH resource modified with respect to the PRACH resource used by the mobile IAB node 300M depending on the confirmation result (step S20) in the target donor node 200-T. Specifically, the F1 setup response message may include a to-be-added-PRACH list (PRACH To Be Added List) including PRACH resources that can be further used in the mobile IAB node 300M for the neighbor donor node 200-TN. The F1 setup response message may include a to-be-modified-PRACH list (PRACH To Be Modified List) including PRACH resources after modification which are PRACH resources that can be used for the neighbor donor node 200-TN with respect to the PRACH resources used in the mobile IAB node 300M. The F1 setup response message may include a to-be-removed-PRACH list (PRACH To Be Remove List) including PRACHs that cannot be used in the mobile IAB node 300M for the neighbor donor node 200-TN.

### Step S22

In step S22, the mobile IAB node 300M modifies PRACH resources in accordance with the list included in the F1 setup response message.

### Another Example of Second Embodiment

Another example of the second embodiment will be described. In another example of the second embodiment, differences from the second embodiment will mainly be described.

In another example of the first embodiment, the target donor node 200-T requests the neighbor donor node 200-TN to provide a PCI list being used in the neighbor donor node 200-TN. This is also applicable to the second embodiment related to a collision of a PRACH resource.

That is, in another example of the second embodiment, an example will be described in which the target donor node 200-T requests the neighbor donor node 200-TN to provide a PRACH resource being used in the neighbor donor node 200-TN.

Specifically, first, a mobile relay node (for example, the mobile IAB node 300M) transmits a F1 setup request message including a first PRACH resource to be used in the mobile relay node to a target donor node (for example, the target donor node 200-T). Second, in response to the reception of the F1 setup request message, the target donor node transmits a serving cell information request message for requesting provision of a PRACH resource to be used in a neighbor donor node, which is adjacent to the target donor node and other than the source donor node, to the neighbor donor node.

This allows the target donor node 200-T to transmit, to the mobile IAB node 300M, a resource other than the PRACH resource being used in the neighbor donor node 200-TN among the PRACH resources used in the mobile IAB node 300M as a PRACH resource that can be used in the mobile IAB node 300M. Thus, for example, different PRACH resources are used in a cell under the control of the mobile IAB node 300M and a cell under the control of the neighbor donor node 200-TN, and a collision of the PRACH resources can be avoided. Thus, the mobile IAB node 300M can appropriately communicate with the UE 100 under the control of the mobile IAB node 300M.

The operation example which is another example of the second embodiment can be implemented by replacing the PCI (or the PCI list) with the PRACH (or the PRACH list) in the operation example (FIG. 12) which is another example of the first embodiment.

### Step S30

In step S30 of FIG. 12, the target donor node 200-T transmits a serving cell information request message for requesting provision of the PRACH resource to the neighbor donor node 200-TN.

### Step S31

In step S31, in response to the reception of the serving cell information request message, the neighbor donor node 200-TN lists up the PRACH resources being used in the neighbor donor node 200-TN.

### Step S32

In step S32, the neighbor donor node 200-TN transmits a serving cell information response message to the target donor node 200-T. The serving cell information response message includes a PRACH (or a list of PRACHs) to be used in the neighbor donor node 200-TN.

### Step S33

In step S33, the target donor node 200-T confirms whether it is necessary to modify the PRACH resource used in the mobile IAB node 300M. The target donor node 200-T may confirm usable PRACH resources by avoiding the PRACH resource used in the neighbor donor node 200-TN for the PRACH resources used in the mobile IAB node 300M. The target donor node 200-T may compare or check the PRACH resources and PRACH resources being used by the target donor node 200-T itself to confirm PRACH resources that can be used in the mobile IAB node 300M.

### Other Embodiments

The operation flows described above can be separately and independently implemented, and also be implemented in combination of two or more of the operation flows. For example, some steps of one operation flow may be added to another operation flow or some steps of one operation flow may be replaced with some steps of another operation flow. In each flow, all steps may not be necessarily executed, and only some of the steps may be executed.

In the above-described embodiments and examples, an example in which the base station is an NR base station (gNB) has been described, but the base station may be an LTE base station (eNB) or a 6G base station. The base station may be a relay node such as an integrated access and backhaul (IAB) node. The base station may be a DU of the IAB node. The UE 100 may be a mobile termination (MT) of the IAB node.

The term “network node” mainly refers to a base station, but may also refer to a device of a core network or a part (a CU, a DU, or an RU) of a base station.

A program causing a computer to execute each of the processing performed by the UE 100 or the gNB 200 may be provided. The program may be recorded on a computer readable medium. Use of the computer readable medium enables the program to be installed on a computer. Here, the computer readable medium on which the program is recorded may be a non-transitory recording medium. The non-transitory recording medium is not particularly limited, and may be, for example, a recording medium such as a CD-ROM or a DVD-ROM.

Circuits for executing processing performed by the UE 100 or the gNB 200 may be integrated, and at least a part of the UE 100 and the gNB 200 may be implemented as a semiconductor integrated circuit (chipset, System on a chip (SoC)).

The phrases “based on” and “depending on/in response to” used in the present disclosure do not mean “based only on” and “only depending on/in response to,” unless specifically stated otherwise. The phrase “based on” means both “based only on” and “based at least in part on”. Similarly, the phrase “depending on/in response to” means both “only depending on/in response to” and “at least partially depending on/in response to”. The terms “include”, “comprise” and variations thereof do not mean “include only items stated” but instead mean “may include only items stated” or “may include not only the items stated but also other items”. The term “or” used in the present disclosure is not intended to be “exclusive or”. Any references to elements using designations such as “first” and “second” as used in the present disclosure do not generally limit the quantity or order of those elements. These designations may be used herein as a convenient method of distinguishing between two or more elements. Thus, a reference to first and second elements does not mean that only two elements may be employed there or that the first element needs to precede the second element in some manner. For example, when the English articles such as “a,” “an,” and “the” are added in the present disclosure through translation, these articles include the plural unless clearly indicated otherwise in context.

The embodiments have been described above in detail with reference to the drawings, but specific configurations are not limited to those described above, and various design variations can be made without departing from the gist of the present disclosure. The embodiments, the operation examples, or the different types of processing may be combined as appropriate as long as they are not inconsistent with each other.

### SUPPLEMENTS

### Supplementary Note 1

A communication control method used in a cellular communication system, the communication control method including:
transmitting, by a mobile relay node to a target donor node, an F1 setup request message including a first physical cell ID used in the mobile relay node; and
in response to reception of the F1 setup request message, transmitting, by the target donor node to a neighbor donor node adjacent to the target donor node and other than a source donor node, a PCI request message including the first physical cell ID in order to perform an inquiry as to whether the first physical cell ID is usable.

### Supplementary Note 2

The communication control method according to supplementary note 1, further including:
in response to reception of the PCI request message, determining, by the neighbor donor node, a second physical cell ID usable by the mobile relay node.

### Supplementary Note 3

The communication control method according to supplementary note 1 or 2, wherein the determining includes determining, by the neighbor donor node, the second physical cell ID depending on whether a physical cell ID used in the neighbor donor node matches the first physical cell ID.

### Supplementary Note 4

The communication control method according to any one of supplementary notes 1 to 3, further including:
transmitting, by the neighbor donor node to the target donor node, a PCI request acknowledge message including the second physical cell ID.

### Supplementary Note 5

The communication control method according to any one of supplementary notes 1 to 4, wherein the transmitting of the PCI request acknowledge message includes transmitting, by the neighbor donor node to the target donor node, the PCI request acknowledge message including a third physical cell ID unusable in the mobile relay node.

### Supplementary Note 6

The communication control method according to any one of supplementary notes 1 to 5, further including:
transmitting, by the target donor node to the mobile relay node, an F1 setup response message including a physical cell ID modified with respect to the first physical cell ID.

### Supplementary Note 7

A communication control method used in a cellular communication system, the communication control method including:
transmitting, by a mobile relay node to a target donor node, an F1 setup request message including a first physical cell ID used in the mobile relay node; and
in response to reception of the F1 setup request message, transmitting, by the target donor node to a neighbor donor node adjacent to the target donor node and other than a source donor node, a serving cell information request message for requesting provision of a physical cell ID to be used in the neighbor donor node.

### Supplementary Note 8

The communication control method according to supplementary note 7, further including:
in response to reception of the serving cell information request message, transmitting, by the neighbor donor node to the target donor node, a serving cell information response message including the physical cell ID being used in the neighbor donor node.

### Supplementary Note 9

A communication control method used in a cellular communication system, the communication control method including:
transmitting, by a mobile relay node to a target donor node, an F1 setup request message including a first physical random access channel (PRACH) resource used in the mobile relay node; and
in response to reception of the F1 setup request message, transmitting, by the target donor node to a neighbor donor node adjacent to the target donor node and other than a source donor node, a PRACH request message including the first PRACH resource in order to perform an inquiry as to whether the first PRACH resource is usable.

### Supplementary Note 10

The communication control method according to supplementary note 9, further including: transmitting, by the neighbor donor node to the target donor node, a PRACH request acknowledge message including a second PRACH resource usable in the mobile relay node.

### Supplementary Note 11

The communication control method according to supplementary note 9 or 10, further including:
transmitting, by the target donor node to the mobile relay node, an F1 setup response message including a PRACH resource modified with respect to the first PRACH resource.

### Supplementary Note 12

A communication control method used in a cellular communication system, the communication control method including:
transmitting, by a mobile relay node to a target donor node, an F1 setup request message including a first PRACH resource used in the mobile relay node; and
in response to reception of the F1 setup request message, transmitting, by the target donor node to a neighbor donor node adjacent to the target donor node and other than a source donor node, a serving cell information request message for requesting provision of a PRACH resource to be used in the neighbor donor node.

### Supplementary Note 13

The communication control method according to supplementary note 12, further including:
in response to reception of the serving cell information request message, transmitting, by the neighbor donor node to the target donor node, a serving cell information response message including the PRACH resource being used in the neighbor donor node.

### REFERENCE SIGNS

1 Cellular communication system
10 5GC
100 UE
110 Radio communicator
120 Controller
200 Donor node (gNB)
200-S Source donor node
200-T Target donor node
210 Radio communicator
230 Controller
300 IAB node
300M Mobile IAB node
310 Radio communicator
320 Controller

1. A communication control method used in a cellular communication system, the communication control method comprising:
transmitting, by a mobile relay node to a target donor node, an F1 setup request message comprising a first physical cell ID used in the mobile relay node; and
in response to reception of the F1 setup request message, transmitting, by the target donor node to a neighbor donor node adjacent to the target donor node and other than a source donor node, a PCI request message comprising the first physical cell ID in order to perform an inquiry as to whether the first physical cell ID is usable.

2. The communication control method according to claim 1, further comprising:
in response to reception of the PCI request message, determining, by the neighbor donor node, a second physical cell ID usable by the mobile relay node.

3. The communication control method according to claim 2,
wherein the determining comprises determining, by the neighbor donor node, the second physical cell ID depending on whether a physical cell ID used in the neighbor donor node matches the first physical cell ID.

4. The communication control method according to claim 2, further comprising:
transmitting, by the neighbor donor node to the target donor node, a PCI request acknowledge message comprising the second physical cell ID.

5. The communication control method according to claim 4,
wherein the transmitting of the PCI request acknowledge message comprises transmitting, by the neighbor donor node to the target donor node, the PCI request acknowledge message comprising a third physical cell ID unusable in the mobile relay node.

6. The communication control method according to claim 2, further comprising:
transmitting, by the target donor node to the mobile relay node, an F1 setup response message comprising a physical cell ID modified with respect to the first physical cell ID.

7. A communication control method used in a cellular communication system, the communication control method comprising:
transmitting, by a mobile relay node to a target donor node, an F1 setup request message comprising a first physical cell ID used in the mobile relay node; and
in response to reception of the F1 setup request message, transmitting, by the target donor node to a neighbor donor node adjacent to the target donor node and other than a source donor node, a serving cell information request message for requesting provision of a physical cell ID to be used in the neighbor donor node.

8. The communication control method according to claim 7, further comprising:
in response to reception of the serving cell information request message, transmitting, by the neighbor donor node to the target donor node, a serving cell information response message comprising the physical cell ID being used in the neighbor donor node.

9. A communication control method used in a cellular communication system, the communication control method comprising:
transmitting, by a mobile relay node to a target donor node, an F1 setup request message comprising a first physical random access channel (PRACH) resource used in the mobile relay node; and
in response to reception of the F1 setup request message, transmitting, by the target donor node to a neighbor donor node adjacent to the target donor node and other than a source donor node, a PRACH request message comprising the first PRACH resource in order to perform an inquiry as to whether the first PRACH resource is usable.

10. The communication control method according to claim 9, further comprising:
transmitting, by the neighbor donor node to the target donor node, a PRACH request acknowledge message comprising a second PRACH resource usable in the mobile relay node.

11. The communication control method according to claim 10, further comprising:
transmitting, by the target donor node to the mobile relay node, an F1 setup response message comprising a PRACH resource modified with respect to the first PRACH resource.

12. A communication control method used in a cellular communication system, the communication control method comprising:
transmitting, by a mobile relay node to a target donor node, an F1 setup request message comprising a first physical random access channel (PRACH) resource used in the mobile relay node; and
in response to reception of the F1 setup request message, transmitting, by the target donor node to a neighbor donor node adjacent to the target donor node and other than a source donor node, a serving cell information request message for requesting provision of a PRACH resource to be used in the neighbor donor node.

13. The communication control method according to claim 12, further comprising:
in response to reception of the serving cell information request message, transmitting, by the neighbor donor node to the target donor node, a serving cell information response message comprising the PRACH resource being used in the neighbor donor node.
